(19) United States
(12) Patent Application Publication
(10) Pub. No.: US 2005/0100133 A1
(43) Pub. Date: May 12, 2005

(54) Microfocus x-ray apparatus

(76) Inventor: Alfred Reinhold, Wunstorf (DE)

Correspondence Address: ROBERT W. BECKER & ASSOCIATES, Suite B, 707 Highway 66 East, Tijeras, NM, 87059, US

(21) Appl. No.: 10/717,300

(22) Filed: Nov. 19, 2003

(30) Foreign Application Priority Data
Nov. 6, 2003 (DE) 103 52 334.0

(51) Int. Cl. H01J 35/14

(52) U.S. Cl. 378/138

(57) ABSTRACT

A method and an apparatus for regulating the intensity of x-ray radiation produced by an x-ray tube of a microfocus x-ray apparatus are provided. The x-ray tube is provided with a target, and a mechanism is provided for bombarding the target with a target stream. At least one parameter of the target stream, in particular a current strength thereof, is regulated.

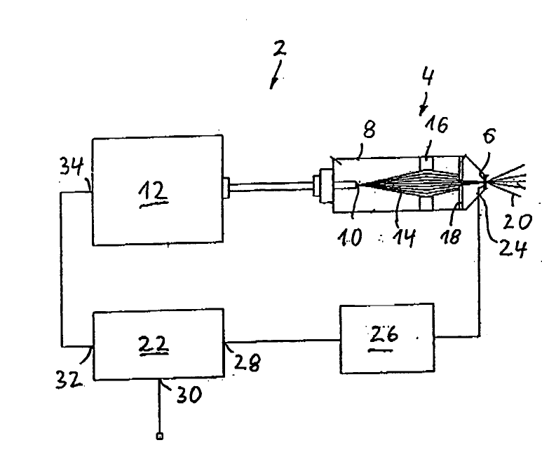

The invention relates to a microfocus x-ray apparatus of the type mentioned in the introductory portion of claim 1, as well as a method for the regulation of the intensity of the x-ray radiation produced by a microfocus x-ray apparatus of the type mentioned in the introductory portion of claim 24.

Microfocus x-ray apparatus are in general known, for example by U.S. Pat. No. 4,344,013, and are used, for example, for testing printed circuit boards in the electronics industry. Corresponding microfocus x-ray apparatus are furthermore known from EP 0 815 582 B1, WO 96/29723 and DE 32 225 11 A1.

Microfocus x-ray apparatus of the pertaining type are known that have a target and means for bombarding the target with a target stream. The known microfocus x-ray apparatus furthermore have means for regulating the intensity (dose rate) of the x-ray radiation that is produced. With the known x-ray apparatus these means are formed, for example, in that an emissions stream emitted from a filament is regulated.

A drawback of the known microfocus x-ray apparatus is that the regulation produced is not adequately reliable. This leads, for example during the testing of an electronic component, to an altering of the brightness of the image during the course of the testing. This limits to a considerable extent in particular the possibilities of an automatic image processing, which requires a constant or nearly constant image brightness.

It is an object of the invention to provide a microfocus x-ray apparatus of the type mentioned in the introductory portion of claim 1 with which the reliability of the regulation is increased.

This object is realized by the teaching provided in claim 1. An inventive method for regulating the intensity (dose rate) of the x-ray radiation produced by a microfocus x-ray apparatus is provided in claim 24.

The basic concept of the inventive teaching is that the intensity of the x-ray radiation (dose rate) is to be regulated such that at least one parameter of the target stream, in particular the current strength of the target stream, is regulated. By regulating the target stream, the intensity (dose rate) of the x-ray radiation produced by the x-ray tube can be regulated with high constancy and reliability. The inventive x-ray apparatus is consequently very usable in particular in areas where a high constancy of the intensity of the x-ray radiation produced is especially desirable. In particular, the inventive x-ray apparatus is especially usable during the testing of electronic components, during which process automatic image processing is used which can then be used with adequate reliability only if the intensity of the x-ray radiation produced is adequately constant.

A particular advantage of the inventive teaching is that due to the regulation of the target stream neither the thermal condition of the x-ray tube and a pertaining high voltage generator, nor an aging of the components of the x-ray apparatus, have any significant influence upon the intensity of the x-ray radiation produced. Even a switching between various types of operation of the x-ray apparatus, with different focal point sizes, does not lead to a significant alteration of the intensity of the x-ray radiation produced when the target stream is regulated.

Pursuant to the invention, various parameters of the target stream can be regulated. Since the target stream is generally a direct current, it is particularly expedient to regulate the current strength of the target stream. However, if the target stream is, for example, a pulsed stream, it would also be possible, for example, to regulate the pulse duration or the aspect ratio of the target stream. If the target stream is an alternating current, then it is possible, for example, to regulate the amplitude and/or the frequency of the target stream.

Pursuant to the invention, it is possible to directly detect the parameter or parameters of the target stream that are to be regulated, for example during regulation of the current strength of the target stream, in such a way that the current strength of the target stream is measured. However, pursuant to the invention it is also possible to indirectly detect the parameter of the target stream that is to be regulated. If the current strength of the target stream is regulated, it is, for example, possible to indirectly detect the current strength of the target stream by detecting electrons that are scattered back from the target stream, thus detecting an “image” of the current strength of the target stream.

Pursuant to a further development of the inventive teaching, the target is electrically insulated relative to a main body of the x-ray tube, and is disposed on the main body. With this embodiment, the current strength of the target stream can be measured with particularly high reliability and can be used as an actual value for the regulation.

A current sensor for detecting an actual value of the current strength of the target stream is expediently provided. The actual value of the target stream detected by the current sensor can, with this embodiment, be used directly as the actual value for the regulation of the target stream. However, it is also possible to base the regulation of the target stream upon a different value or parameter, for example on an electrical parameter that is a function of the target stream. In particular, it is possible to convert the measured target stream into a voltage, and to use this voltage as the actual value for the regulation.

The means for regulating the target stream are expediently provided with a regulating device.

Pursuant to a further development of the aforementioned embodiment, the regulating device compares a detected actual value of the target stream with a prescribed value of the target stream and alters a control or adjustment value such that the difference between the desired value and the actual value is minimized. With the aforementioned embodiment, the regulation can also be effected upon the basis of electrical parameters that are a function of the target stream. In particular, the actual value of the target stream can be converted into a voltage that is then conveyed as the actual value to the regulating device, which compares this voltage with a prescribed desired value of a voltage that is a function of a control value of the target stream, and alters the control value in such a way that the difference between the desired value and the actual value is minimized.

The microfocus x-ray apparatus expediently has a high voltage regulator for producing a high voltage that is preferably essentially constant and by means of which the electrons, preferably electrons released from a cathode, and which serve for the generation of an emission stream of the x-ray tube, are accelerated in a direction toward the target.

In principle to achieve a particularly straightforward and reliable regulation of the target stream, pursuant to a further development of the aforementioned embodiment the control value is the emission stream.

Pursuant to another further development of the inventive teaching, the regulating device is provided with an electrical or electronic control circuit that forms a controller. With this embodiment, the controller is realized by hardware.

In conformity with the respective requirements, the regulating device can, however, also be realized by software. For this purpose, pursuant to an advantageous further development of the inventive teaching, the regulating device has an electronic control circuit that can be controlled by a regulating software in such a way that the regulation is effected in a software-controlled manner. The particular advantage of this embodiment is that the regulation of the target stream can be altered in a simple manner by altering the software.

Pursuant to an advantageous further development of the aforementioned embodiment, the electronic control circuit is provided with a micro controller or the like. Such micro controllers are available as straightforward and economical standard components.

In principle, the regulation of the target stream can be continually activated during the operation of the x-ray apparatus. However, pursuant to a particularly advantageous further development of the inventive teaching, the regulation of the target stream can be activated and deactivated. With this embodiment, the activation or deactivation of the regulation of the target stream can be effected by a user and/or can be automatically effected. For example, the regulation of the target stream can then be deactivated if a stable regulation of the target stream is not possible, for example due to momentary operating parameters of the x-ray device, in order to prevent a malfunction of the regulation.

Pursuant to a further development of the aforementioned embodiment, with the regulation of the target stream being deactivated, a further regulating device regulates the emission stream of the x-ray tube. With this embodiment, after a deactivation of the regulation of the target stream, the emission stream of the x-ray tube is regulated. Even if by regulating the emission stream a regulation of the intensity of the x-ray radiation produced is not possible with adequate precision, nonetheless the regulation of the emission stream ensures that fluctuations of the intensity are kept within a certain limit.

Pursuant to another further development of the inventive teaching, a momentary flowing target stream during the activation of the regulation of the target stream forms the desired value of the target stream. This embodiment makes it possible to keep constant the intensity of the x-ray radiation that is present during activation of the regulation, and hence the brightness of the image that is provided.

Pursuant to another further development of the embodiment having the regulation of the emission stream, a momentary flowing emission stream during the deactivation of the regulation of the target steam forms a desired value for the regulation of the emission stream by the further regulating device. With this embodiment, during the deactivation of the regulation of the target stream the brightness of the image does not change.

Pursuant to another advantageous further development of the inventive teaching, the regulating device regulates the target stream in order to prevent a prescribed or prescribable maximum electrical output of the target from being exceeded. With this embodiment, damage to the target due to an electrical overloading, which can occur, for example, due to an overshooting during the activation, is reliably avoided.

Pursuant to a further advantageous development of the inventive teaching, an activation of the regulation of the target stream is effected in a chronologically delayed manner after an activation of the microfocus x-ray tube. This ensures that the regulation of the target stream is then activated only when a stable operation of the regulation is possible.

Pursuant to a further development of the aforementioned embodiment, an activation is effected when the emission stream has achieved a prescribed or prescribable desired valued. This embodiment ensures that the regulation is not activated approximately at a point in time in which no emission stream is flowing yet.

Since the characteristics of the control system of the regulation of the target stream formed by the high voltage generator, the pertaining high voltage cable, and the x-ray tube are under certain circumstances to a considerable extent a function of the high voltage, it is proposed pursuant to an advantageous further development of the inventive teaching that regulating parameters of the regulating device be alterable as a function of the high voltage.

A further development of the aforementioned embodiment in particular provides that with a reduction of the high voltage the regulating parameters are altered in such a way that the time lag of the regulation is increased, and that with an increase of the high voltage the regulating parameters are altered such that the time lag of the regulation is reduced. With this embodiment, the time lag of the regulation is adapted to the conditions that exist with regard to the high voltage in the x-ray tube.

In the event that it is necessary in conformity with the respective requirements, the x-ray tube can be provided with means via which the emission stream can be deflected or blocked in such a way that the striking of the target by the emission stream is essentially prevented.

Pursuant to a further development of the aforementioned embodiment, if the means for deflecting or blocking the emission stream are activated a deactivation of the regulation of the target stream is effected. This reliably prevents malfunctions of the regulation.

Pursuant to another further development of the inventive teaching, means are provided for determining whether a short circuit is present at the target, whereby when a short circuit is detected, the means deactivate the regulation of the target stream. This prevents the target, in the event of a short circuit, where the target stream is entirely or partially diverted, from being destroyed by a target stream that is too great.

An inventive method for the regulation of the intensity of the x-ray radiation produced by an x-ray apparatus is provided in claim 24.

Advantageous and expedient further developments of the teaching of claim 24 are provided in the dependent claims 25 to 39.

The invention will be explained in greater detail subsequently with reference to the accompanying drawing, the single FIGURE of which shows a very schematic block diagram of an inventive x-ray apparatus for carrying out the inventive method. In this connection, all of the described features or the features illustrated in the drawing form the subject matter of the invention, either by themselves or in any desired combination, independently of their combination in the claims or their back reference, as well as independently of their formulation or illustration in the specification or in the drawing.

Illustrated in the drawing is an embodiment of one inventive microfocus x-ray apparatus 2, which will subsequently be abbreviated as x-ray apparatus. The x-ray apparatus has an x-ray tube 4 that is provided with a target that is disposed on a main body 8 of the x-ray tube 4.

Although it is not visible from the drawing, and will therefore not be explained in detail here, the target 6 is disposed on the main body 8 such that it is electrically insulated relative to the main body 8 of the x-ray tube 4. The insulation can, for example, be comprised of ceramic or the like.

The x-ray apparatus 2 is furthermore provided with means for bombarding the target 6 with a target stream, which means have a heating filament 10 in the form of a cathode. The means for bombarding the target 6 with a target stream are furthermore provided with a high voltage generator 12 for producing a variable, although after a variation essentially constant, high voltage, by means of which electrons, which are released from the heating filament 10 in a vacuum that is present in the interior of the main body 4, are accelerated in the direction of the target 6, whereby x-ray radiation results, in a manner known to one of skill in the art, when the electrons strike the target 6.

The electrons that are emitted from the heating element 10, and that are accelerated by the high voltage in the direction toward the target 6, form an emission stream 14 that is focused by a coil 16. Disposed downstream of the coil 16, as viewed in the direction of movement of the electrons, is an apertured partition 18 that serves for reducing the diameter of the electron stream such that the x-ray tube has a focus or focal point having a diameter of ≦200 μm, especially ≦10 μm, so that the x-ray tube 4 is embodied as a microfocus x-ray tube. That portion of the emission stream that reaches the target 6 forms a target stream.

The x-ray apparatus 2 is furthermore provided with means for regulating the intensity (dose rate) of the x-ray radiation that is produced, and which is symbolized in the drawing by the reference numeral 20, whereby pursuant to the invention, the means is provided with means for the regulation of the current strength of the target stream. With the embodiment illustrated in the drawing, the parameter of the target stream that is to be regulated is the current strength of the target stream. The means for regulating the target stream are, in this embodiment, provided with a regulating device 22 that in this embodiment has a micro controller that can be controlled by a regulation software in such a way that the regulation of the current strength of the target stream is effected in a software-controlled manner.

The x-ray apparatus 2 is furthermore provided with a sensor 24 that senses the target stream at the target 6 and feeds a measurement amplifier 26. The measurement amplifier 26 amplifies the measured target stream, whereby the output signal of the measurement amplifier forms an actual value of the current strength of the target stream that is conveyed to the input 28 of the regulating device 22. By means of a further input 30, the regulating device 22 is furthermore supplied with a desired value of the current strength of the target stream, whereby the regulating device 22 compares the detected actual value of the target stream with the desired value of the target stream and alters a control or adjustment value such that the difference between the desired value and the actual value is minimized.

With the embodiment illustrated in the drawing, the emission stream forms the control value of the regulation. As is known in general, the emission stream is produced in that electrons are emitted from the heating element 10 and are accelerated, in the direction toward the target, by the high voltage produced by the high voltage generator 12. It is not illustrated in the drawing, and therefore will not be explained in detail here, that disposed downstream of the heating element 10, as viewed in the direction of movement of the electrons, is a grid or the like to which can be applied a voltage that is also produced by the high voltage generator 12. By altering the voltage at the grid, the emission stream can be altered, whereby if the voltage applied to the grid is increased, the emission stream is reduced, and if the voltage applied to the grid is reduced, the emission stream is increased.

For influencing the control value, an output 32 of the regulating device 22 is connected with a control input 34 of the high voltage generator 12, whereby the voltage that is applied to the grid, and hence to the emissions stream, can be altered via the control input 34.

The manner of operation of the inventive x-ray apparatus 2 is as follows:

During operation of the x-ray apparatus 2, the heating filament 10 is heated such that in the vacuum electrons exit the heating element 10. By means of the high voltage generator there is produced between the target 6, which acts as the anode, and the heating filament 10, which acts as the cathode, a high voltage, due to which the electrons that are emitted from the heating filament 10 are accelerated in the direction toward the target 6 and form an emission stream of the x-ray tube 4. The emission stream 14 is focused by means of the coil 16 and the partition 18, whereby a portion of the emission stream 14 that reaches the target forms the target stream. Upon striking the target 6, the electrons produce, in a manner known to one of skill in the art, the x-ray radiation 20, which with the embodiment is used to test electronic components.

During the operation of the x-ray apparatus 2, the sensor 24 senses the target stream, which after amplification by the measurement amplifier 26 is applied as the detected actual value of the target stream to the input 28 of the regulating device 22. The regulating device 22 compares the detected actual value with a control value that is present at the input 30 and minimizes the difference between the prescribed or prescribable desired value and the detected actual value.

Should it be determined via the regulating device 22 that the actual value of the target stream has been reduced, which would result in a reduction of the brightness of an image produced by the x-ray radiation 20, the regulating device 22 increases the emission stream in the manner described above. As a consequence, the current strength of the target stream increases until the difference between the detected actual value of the target stream and the desired value become zero. In contrast, if the current strength of the target stream increases, the regulating device 22 reduces the emission stream via the control input 34, so that the current strength of the target stream is reduced until the difference between the detected actual value and the desired value becomes zero.

In this way, the target stream is regulated and is kept constant with greater precision, so that the intensity (dose rate) of the x-ray radiation that is produced is kept constant. Consequently, the brightness of an image produced via the x-ray radiation for the testing of an electronic component remains constant, thereby enabling or significantly simplifying an evaluation or interpretation of the image via an automatic image processing.

With this embodiment, the regulating device 22 is embodied in such a way that the regulation of the target stream can be switched on and off.

Pursuant to the invention, the regulation of the target stream, after the x-ray tube 4 has been switched on, is activated in a chronologically delayed manner in order to prevent a malfunctioning of the regulation during a start-up of the x-ray apparatus 2, during which the x-ray tube 4 is warmed up for the operation, the voltage at the hearing filaments 10 is adjusted, and the electron stream is centered. With the embodiment, the emission stream is measured and the regulation is then activated when the emission stream has reached a prescribed or prescribable desired value.

With the embodiment, a target stream that momentarily flows during activation of the regulation of the target stream forms the desired value of the target stream that is conveyed to the control input 30 of the regulating device 22.

Furthermore, with the embodiment, when the regulation of the target stream is not activated, the emission stream of the x-ray tube is regulated by a further regulating device, which is not illustrated in the drawing, whereby an emission stream that momentarily flows during the deactivation of the regulation of the target stream prescribes a desired value for the regulation of the emission stream by the further regulating device. In this way, there is avoided an alteration of the brightness of the image during a deactivation of the regulation of the target stream.

Furthermore, with the embodiment, and with a change of the desired value of the high voltage, which is again essentially constant after the change, the regulation of the target stream is deactivated until a new desired value of the high voltage is achieved. Furthermore, with the embodiment, regulating parameters of the regulating device 22 can be altered as a function of the high voltage produced by the high voltage generator 12, and in particular in such a way that when the high voltage is reduced, the regulating parameters are altered in such a way that the time lag of the regulation is increased, and that with an increase of the high voltage the regulating parameters are altered in such a way that the time lag of the regulation is reduced.

From the drawing it cannot be seen, and therefore it will not be explained in greater detail here, that the x-ray tube 4 is provided with means for deflecting or blocking the emission stream in such a way that the emission stream can essentially be prevented from striking the target. Upon activation of these means, also designated as a shutter, the regulation of the target stream of the embodiment is deactivated.

To protect the target 6 from damage, with the embodiment the regulating device 22 regulates the target stream in such a way that a prescribed or prescribable maximum output of the target cannot be exceeded. Furthermore, via means not illustrated in the drawing it can be determined whether a short circuit is present at the target 6, whereby these means deactivate the regulation of the target stream when a short circuit is determined. In this way, with the embodiment damage or destruction of the target due to overloading is reliably prevented.

The inventive x-ray apparatus 2, in a straightforward and reliable manner, enables a regulation of the intensity (dose rate) of the x-ray radiation that is produced.

1-40. (canceled)

41. A microfocus x-ray apparatus, comprising:
an x-ray tube that is provided with a target;
means for bombarding the target with a target stream; and
means for regulating the intensity of x-ray radiation that is produced, wherein said means for regulating includes means for regulating at least one parameter of said target stream, in particular a current strength of said target stream.

42. A microfocus x-ray apparatus according to claim 41, wherein said target 6 is disposed on a main body of said x-ray tube such that it is electrically insulated relative to said main body.

43. A microfocus x-ray apparatus according to claim 41, wherein a current sensor is provided for detecting an actual value of a current strength of said target stream.

44. A microfocus x-ray apparatus according to claim 41, wherein said means for regulating at least one parameter of said target stream includes a regulating device.

45. A microfocus x-ray apparatus according to claim 44, wherein said regulating device compares a detected actual value of said target stream with a prescribed desired value of said target stream and alters a control value in such a way that any difference between said desired value and said actual value is minimized.

46. A microfocus x-ray apparatus according to claim 41, wherein a high voltage generator is provided for producing a preferably essentially constant high voltage by means of which electrons for generating an emission stream of said x-ray tube are accelerated in a direction toward said target.

47. A microfocus x-ray apparatus according to claim 45, wherein said control value is an emission stream of said x-ray tube.

48. A microfocus x-ray apparatus according to claim 44, wherein said regulating device is provided with an electrical or electronic control circuit that forms a controller.

49. A microfocus x-ray apparatus according to claim 44, wherein said regulating device is provided with an electronic control circuit that is adapted to be controlled by a regulation software in such a way that regulation is effected in a software-controlled manner.

50. A microfocus x-ray apparatus according to claim 48, wherein said regulating device is provided with an electronic control circuit that includes a microcontroller.

51. A microfocus x-ray apparatus according to claim 41, wherein regulation of said target stream is adapted to be activated and deactivated.

52. A microfocus x-ray apparatus according to claim 51, wherein a further regulating device is provided for regulating an emission stream of said x-ray tube when regulation of said target stream is deactivated.

53. A microfocus x-ray apparatus according to claim 51, wherein a target stream that momentarily flows when regulation of said target stream is activated forms a desired value of said target stream.

54. A microfocus x-ray apparatus according to claim 52, wherein an emission stream that momentarily flows when regulation of said target stream is deactivated forms a desired value for regulation of said emission stream by said further regulating device.

55. A microfocus x-ray apparatus according to claim 44, wherein said regulating device regulates said target stream in such a way that an exceeding of a prescribed or prescribeable maximum electrical output of said target is prevented.

56. A microfocus x-ray apparatus according to claim 51, wherein after an activation of said x-ray tube an activation of regulation of said target stream is effected in a chronologically delayed manner.

57. A microfocus x-ray apparatus according to claim 56, wherein activation of regulation of said target stream is effected when an emission stream of said x-ray tube achieves a prescribed or prescribeable desired value.

58. A microfocus x-ray apparatus according to claim 46, wherein regulation of said target stream is adapted to be activated and deactivated, and wherein upon an alteration of a desired value of said high voltage, a deactivation of regulation of said target stream is effected until a new desired value of said high voltage is achieved.

59. A microfocus x-ray apparatus according to claim 45, wherein regulating parameters of said regulating device are alterable as a function of said high voltage.

60. A microfocus x-ray apparatus according to claim 59, wherein upon a reduction of said high voltage said regulating parameters are altered in such a way that a lag time of regulation of said target stream is increased, and wherein upon an increase of said high voltage said regulating parameters are altered in such a way that the lag time of the regulation is reduced.

61. A microfocus x-ray apparatus according to claim 41, wherein said x-ray tube is provided with means via which an emission stream of said x-ray tube can be deflected or blocked in such a way that a striking of said emission stream upon said target is essentially prevented.

62. A microfocus x-ray apparatus according to claim 61, wherein regulation of said target stream is adapted to be activated and deactivated, and wherein upon activation of said means for deflecting or blocking said emission stream, a deactivation of regulation of said target stream is effected.

63. A microfocus x-ray apparatus according to claim 51, wherein means are provided for determining whether a short circuit is present at said target, and wherein upon determination of a short circuit, said determining means deactivate regulation of said target stream.

64. A method of regulating the intensity of x-ray radiation produced by an x-ray tube of a microfocus x-ray apparatus, wherein said x-ray tube is provided with a target and with means for bombarding said target with a target stream, said method including the step of:
regulating at least one parameter of said target stream, in particular a current strength of said target stream.

65. A method according to claim 64, wherein an actual value of a current strength of said target stream is detected.

66. A method according to claim 64, wherein a detected actual value of said target stream is compared with a prescribed desired value of said target stream and alters a control value in such a way that a difference between said desired value and said actual value is minimized.

67. A method according to claim 64, wherein a high voltage generator is provided by means of which a preferably essentially constant high voltage is produced via which electrons for producing an emission stream of said x-ray tube are accelerated in a direction toward said target.

68. A method according to claim 67, wherein said emission stream is used as a control value.

69. A method according to claim 64, wherein regulation of said target stream is adapted to be activated and deactivated.

70. A method according to claim 69, wherein an emission stream of said x-ray tube is regulated when regulation of said target stream is deactivated.

71. A method according to claim 69, wherein a target stream that momentarily flows during activation of regulation of said target stream is used as a desired value of said target stream.

72. A method according to claim 69, wherein an emission stream of said x-ray tube that momentarily flows upon deactivation of regulation of said target stream is used as a desired value for regulating said emission stream.

73. A method according to claim 64, wherein said at least one parameter of said target stream is regulated in such a way that an exceeding of a prescribed or prescribeable maximum electrical output of said target is prevented.

74. A method according to claim 69, wherein upon an activation of said microfocus x-ray apparatus regulation of said target stream is activated in a chronologically delayed manner.

75. A method according to claim 74, wherein regulation of said target stream is activated when an emission stream 14 of said x-ray tube 4 has achieved a prescribed or prescribeable desired value.

76. A method according to claim 69, wherein upon alteration of a desired value of a high voltage of a high voltage generator 12, regulation of said target stream is deactivated until a new desired value of said high voltage is achieved.

77. A method according to claim 64, wherein regulating parameters of regulation of said target stream are altered as a function of high voltage of a high voltage generator 12.

78. A method according to claim 77, wherein upon a reduction of said high voltage said regulating parameters are altered in such a way that a lag time of regulation of said target stream is increased, and wherein upon an increase of said high voltage said regulating parameters are altered in such a way that the lag time of the regulation of said target stream is reduced.

79. A method according to claim 69, wherein upon a deflection or blocking of an emission stream 14 of said x-ray tube 4 in such a way that a striking of said emission stream upon said target 6 is essentially prevented, regulation of said target stream is deactivated.

80. A method according to claim 69, which includes the steps of determining whether a short circuit is present at said target 6, and upon determination of a short circuit deactivating regulation of said target stream.
